(19) United States
(12) Patent Application Publication
(10) Pub. No.: US 2025/0319747 A1
(43) Pub. Date: Oct. 16, 2025

(54) Work Vehicle

(71) Applicant: Kubota Corporation, Osaka-shi (JP)

(72) Inventors: Shinya Tabata, Osaka (JP); Taisuke Hashimoto, Osaka (JP); Kohta Nakao, Osaka (JP); Kazuhiro Tanaka, Osaka (JP)

(21) Appl. No.: 18/977,233

(22) Filed: Dec. 11, 2024

(30) Foreign Application Priority Data
Apr. 11, 2024 (JP) 2024-064042

(51) Int. Cl. B60H 1/32; B60H 1/00

(52) U.S. Cl. CPC B60H 1/3208; B60H 1/00357

(57) ABSTRACT

A work vehicle includes a gasoline engine, a drive cabin covering a cabin space, an air conditioner device including a compressor driven by the gasoline engine, an air conditioning unit configured to generate an air conditioning airflow supplied to the cabin space, and an air conditioner control unit configured to control the air conditioner device. The compressor is driven in response to a compressor drive command at start of the air conditioner device which compressor drive command is issued based on engine state information on a state of the gasoline engine.

### CROSS-REFERENCE TO RELATED APPLICATION

This application claims priority to Japanese Patent Application No. 2024-064042 filed Apr. 11, 2024, the disclosure of which is hereby incorporated by reference in its entirety.

### BACKGROUND OF THE INVENTION

### 1. Field of the Invention

The present invention relates to a work vehicle including a gasoline engine and an air conditioner device, and the air conditioner device includes an air conditioning unit configured to supply an air conditioning airflow to a cabin space covered with a drive cabin, and a compressor driven by the gasoline engine.

### 2. Description of Related Art

Japanese Unexamined Patent Application Publication No. 2017-109645 discloses a gasoline-type multipurpose vehicle including a drive cabin covering a cabin space, and an air conditioning system configured to perform air-conditioning in the cabin space. The air conditioning system includes an air conditioning unit, a condenser, a compressor, a first refrigerant pipe, a second refrigerant pipe, a third refrigerant pipe, and an engine. The air conditioning unit generates an airflow to be supplied to the cabin space.

In the case of a gasoline engine, robustness to an abrupt load is low in comparison with a diesel engine or the like. Accordingly, the work vehicle disclosed in Japanese Unexamined Patent Application Publication No. 2017-109645 has such a problem that an engine stall occurs when the air conditioner device is turned on to actuate the compressor driven by the engine at the time of cold start at which an engine starting load increases, or at the time when an external power device (a PTO device) is used.

### SUMMARY OF THE INVENTION

In view of the foregoing, a work vehicle including an air conditioner device driven by power from a gasoline engine is desired to restrain an engine stall even under a situation where an engine load becomes high.

A work vehicle according to the present invention includes: a gasoline engine; a drive cabin covering a cabin space; an air conditioner device including a compressor driven by the gasoline engine, and an air conditioning unit configured to generate an air conditioning airflow supplied to the cabin space; and an air conditioner control unit configured to control the air conditioner device. The compressor is driven in response to a compressor drive command at start of the air conditioner device which compressor drive command is issued based on engine state information on a state of the gasoline engine.

With this configuration, at the time of starting the air conditioner device, the compressor drive command to drive the compressor drive is issued based on the engine state information on the state of the gasoline engine. That is, in a case where the engine state based on the engine state information is unlikely to cause an engine stall by the driving of the compressor, the compressor is driven, but in a case where the engine state is likely to cause an engine stall by the driving of the compressor, the compressor is not driven. Hereby, in the work vehicle, it is possible to restrain an engine stall even under a situation where a load to the engine becomes high.

The work vehicle includes a plurality of control units each called an ECU. The control units are connected to each other via an in-vehicle LAN or the like, and each of the control units has a function necessary to drive the vehicle. In a case where the work vehicle includes, as one of the control units, an engine control unit configured to control the engine based on the engine state information such as a detected engine rotation speed or engine load, the other control units can acquire the engine state information from the engine control unit. In view of this, in the present invention, the work vehicle may include an engine control unit configured to control the gasoline engine and generate the engine state information. Hereby, the other control units can acquire the engine state information.

In order to avoid an engine stall caused by the driving of the compressor, an engine output (torque) that endures the driving of the compressor is required. When the engine has an idling rotation speed (a startup rotation speed), the engine output (torque) is low. However, as the engine rotation speed increases from the startup rotation speed, the engine output (torque) increases. Accordingly, in order to avoid an engine stall caused by the driving of the compressor, it is preferable that the compressor be driven when a condition that the engine rotation speed increases from around the idling rotation speed and becomes higher than a predetermined rotation speed is satisfied. In view of this, in the present invention, the engine state information may be an engine rotation speed, the gasoline engine may be controlled to satisfy a determination condition that the engine rotation speed reaches a predetermined rotation speed, in a case where the determination condition is not satisfied, and the compressor drive command may be issued in response to the determination condition being satisfied. The predetermined rotation speed for the determination condition is determined based on the type of the engine provided for the work vehicle, or the like.

The driving (ON/OFF) of the air conditioner device is performed by an operation tool such as a switch or a button, and an air conditioner start operation signal generated in response to the operation on such an operation tool is processed by the air conditioner control unit configured to control the air conditioner device. In a case where the air conditioner control unit is configured as a control unit such as an ECU and can exchange data with the other control units each as an ECU via the in-vehicle LAN or the like, the start management of the air conditioner device can be shared with the other control units. In view of this, in one preferred embodiment of the present invention, the engine control unit may receive an air conditioner start operation signal via the air conditioner control unit which air conditioner start operation signal is to start driving of the air conditioner device, and the engine control unit may issue the compressor drive command. Hereby, the compressor is driven when a condition that the engine is in a state suitable for driving of the compressor (a state where no engine stall occurs) is satisfied.

In another preferred embodiment of the present invention, the work vehicle may include a meter control unit configured to manage a meter device displaying a current state of the work vehicle and to receive the engine rotation speed. The meter control unit may receive an air conditioner start operation signal from the air conditioner control unit which air conditioner start operation signal is to start driving of the air conditioner device, and the meter control unit may issue the compressor drive command based on the engine rotation speed. Even with this configuration, the compressor is driven when a condition that the engine is in a state suitable for driving of the compressor (a state where no engine stall occurs) is satisfied.

In further another preferred embodiment of the present invention, the work vehicle may further include a meter control unit configured to manage a meter device displaying a current state of the work vehicle. The engine control unit may receive an air conditioner start operation signal from the air conditioner control unit via the meter control unit which air conditioner start operation signal is to start driving of the air conditioner device, and the engine control unit may issue the compressor drive command. Even with this configuration, the compressor is driven when a condition that the engine is in a state suitable for driving of the compressor (a state where no engine stall occurs) is satisfied.

### BRIEF DESCRIPTION OF THE DRAWINGS

FIG. 1 is a side view of a multipurpose vehicle;

FIG. 2 is a plan view of the multipurpose vehicle from which a cabin is removed;

FIG. 3 is a schematic configuration diagram of an air conditioner device;

FIG. 4 is a block diagram illustrating a data flow between control units at the startup of the air conditioner device;

FIG. 5 is a block diagram illustrating a data flow between the control units at the startup of the air conditioner device in another embodiment; and

FIG. 6 is a block diagram illustrating a data flow between control units at the startup of the air conditioner device in further another embodiment.

### DESCRIPTION OF THE INVENTION

The following describes a multipurpose vehicle as an example of a work vehicle of the present invention. Note that, in the following description, in terms of the multipurpose vehicle, a direction of an arrow F illustrated in the drawings is referred to as a “vehicle-body front side,” a direction of an arrow B is referred to as a “vehicle-body rear side,” a direction of an arrow U is referred to as a “vehicle-body upper side,” a direction of an arrow D is referred to as a “vehicle-body lower side,” a direction of an arrow L is referred to as a “vehicle-body left side,” and a direction of an arrow R is referred to as a “vehicle-body right side.”

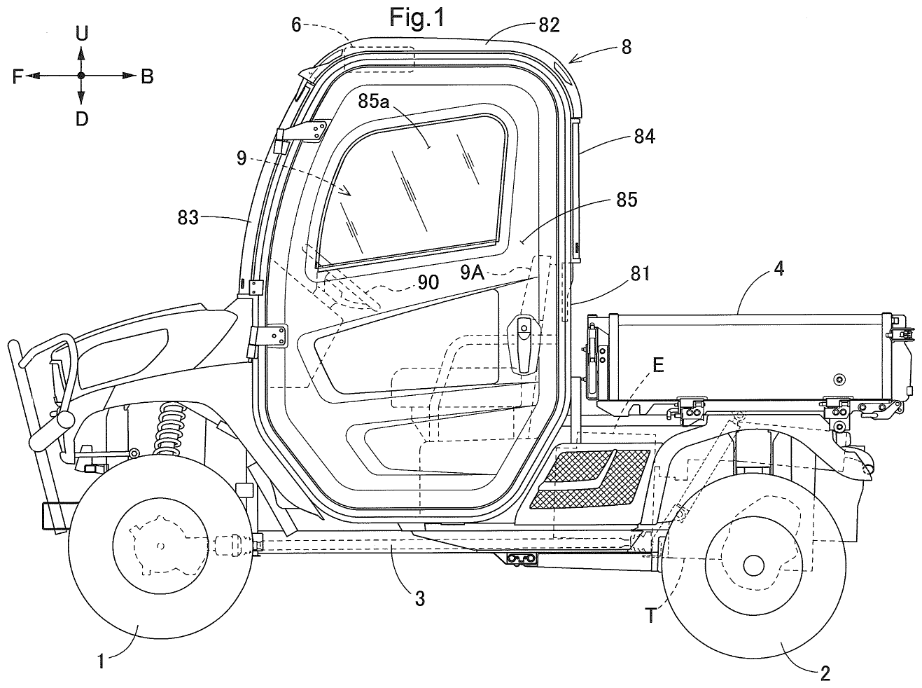

As illustrated in FIG. 1, the multipurpose vehicle includes a body frame 3 supported by a pair of right and left front wheels 1 and a pair of right and left rear wheels 2 in such a manner as to be grounded. The front wheels 1 are drivable and steerable, and the rear wheels 2 are drivable. A driving section 9 as a cabin space is at a front portion of the body frame 3. A cargo box 4 is at a rear portion of the body frame 3. A gasoline engine E and a transmission T are under the cargo box 4. The gasoline engine E is hereinafter just referred to as the engine E.

The multipurpose vehicle includes a drive cabin 8 covering the driving section 9, and an air conditioner device 6 configured to perform air-conditioning in the drive cabin 8. The drive cabin 8 includes a cabin frame 81, a roof 82, a windshield 83, a rear window 84, a pair of right and left side doors 85 that are openable and closable, or the like. A side window 85a having translucency is attached to each of the right and left side doors 85. The right and left side doors 85 each include the side window 85a that is openable and closable in such a manner as to swing around an opening-closing axis along a vertical direction. The roof 82 covers the whole upper side of the driving section 9.

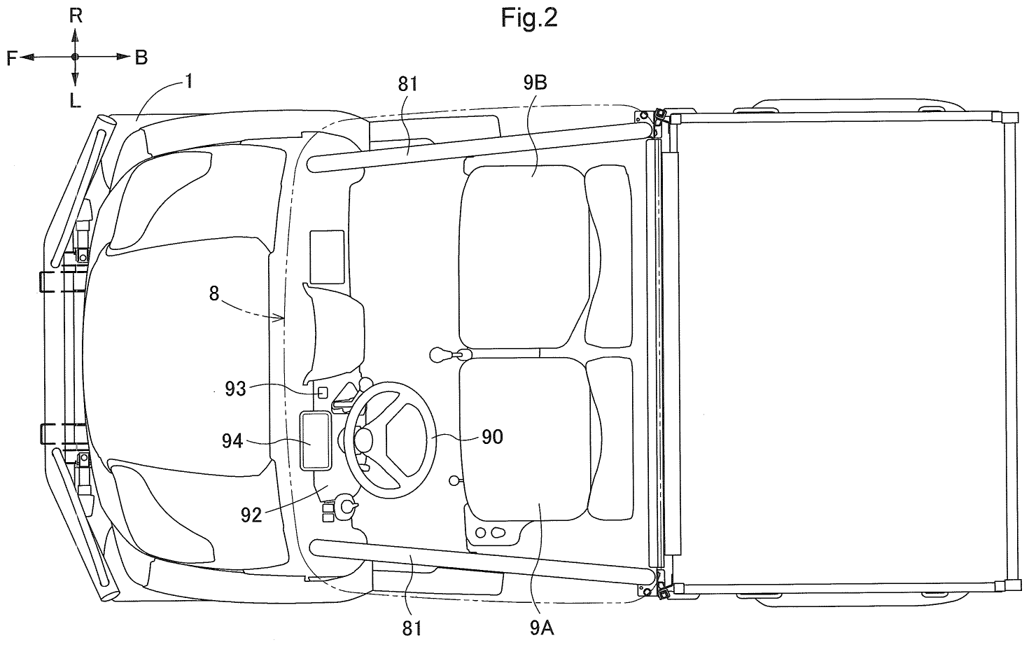

As illustrated in FIG. 2, the driving section 9 is provided with a driver seat 9A and a passenger seat 9B. A steering wheel 90 is forward of the driver seat 9A, and a dashboard including an instrument panel 92 is forward of the steering wheel 90. A display 94 as a display device and various operation buttons are provided for the instrument panel 92. The various operation buttons include an air conditioner switch 93 as an operation tool for performing driving (ON/OFF) of the air conditioner device 6. An air conditioner start operation signal (ON operation signal) is output in response to an ON operation of the air conditioner switch 93. An air conditioner stop operation signal (OFF operation signal) is output in response to an OFF operation of the air conditioner switch 93.

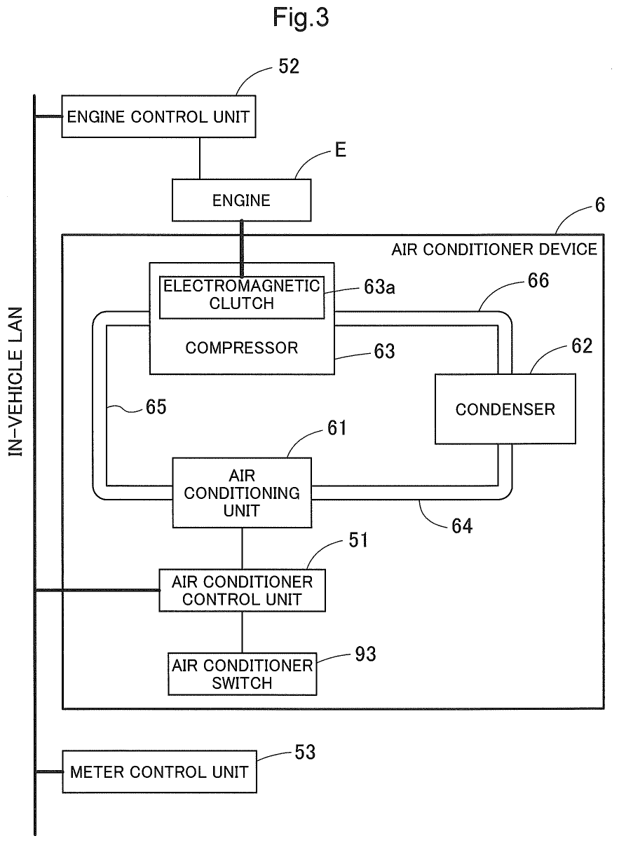

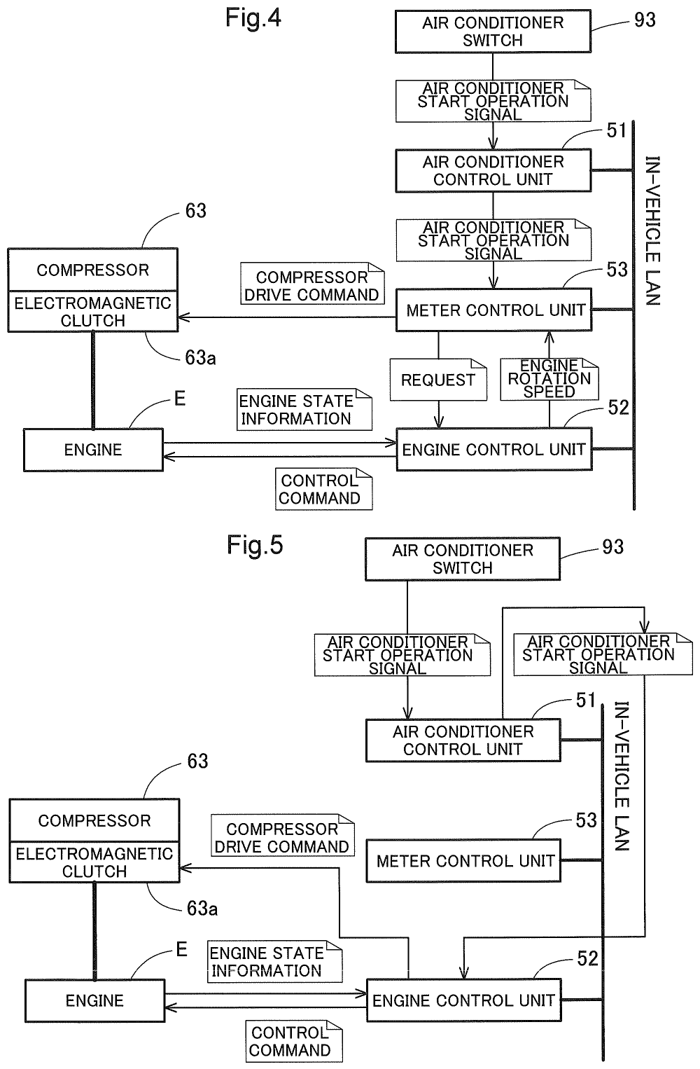

As illustrated in FIG. 3, the air conditioner device 6 includes an air conditioning unit 61, a condenser 62, a compressor 63, a first refrigerant pipe 64, a second refrigerant pipe 65, and a third refrigerant pipe 66. The air conditioner device 6 further includes an air conditioner control unit 51 (see FIG. 4).

The air conditioner control unit 51 constitutes a control system of the air conditioner device 6 and adjusts the temperature, the flow rate, or the like of an air conditioning airflow.

The air conditioning unit 61 is at an upper portion of the drive cabin 8 (see FIG. 1) and is configured to generate an airflow supplied into the drive cabin 8. The condenser 62 is a condenser for cooling a refrigerant. The condenser 62 is disposed near a radiator (not illustrated) as an engine device, and the condenser 62 is also cooled off together with the radiator by a cooling fan (not illustrated) for the radiator. The compressor 63 is a compressor to compress the refrigerant and is disposed near the engine E because the compressor 63 is driven by power from the engine E. An electromagnetic clutch 63a is provided for a transmission shaft for transmitting engine power to the compressor 63. While the engine E is being driven, the compressor 63 is driven in response to the electromagnetic clutch 63a being turned on, and the compressor 63 stops in response to the electromagnetic clutch 63a being turned off.

The first refrigerant pipe 64 sends the refrigerant from the condenser 62 to the air conditioning unit 61. The first refrigerant pipe 64 is disposed along a longitudinal frame constituting the drive cabin 8. The second refrigerant pipe 65 sends the refrigerant from the air conditioning unit 61 to the compressor 63. The second refrigerant pipe 65 is also disposed along the longitudinal frame constituting the drive cabin 8. The third refrigerant pipe 66 sends the refrigerant from the compressor 63 to the condenser 62.

FIG. 4 illustrates control units (ECUS) related to the control of the air conditioner device 6 in the control system of the multipurpose vehicle. Here, the control units include the air conditioner control unit 51, an engine control unit 52, and a meter control unit 53 that are connected to each other via an in-vehicle LAN. The engine control unit 52 provides an engine control signal for controlling the engine E to a control device of the engine E, and receives engine information (based on a detecting signal from a sensor or the like provided for the engine E) on an engine rotation speed, an engine load, or the like of the engine E. The meter control unit 53 has a meter device management function to collect data from each control unit and display a vehicle state (a totalizing distance, a vehicle speed, remaining fuel, water temperature, a shift position, and so on) in real time. The meter control unit 53 also has a lighting control function of an alarm lamp configured to notify an abnormality of the vehicle.

FIG. 4 illustrates a first embodiment related to a data flow until the air conditioner device 6 starts operating after the air conditioner switch 93 is turned on. In the first embodiment, the air conditioner start operation signal sent to the air conditioner control unit 51 in response to the air conditioner switch 93 being turned on is transferred to the meter control unit 53. The meter control unit 53 that has received the air conditioner start operation signal requests the engine control unit 52 to send an engine rotation speed and compares a received engine rotation speed with a predetermined air-conditioner drive permission engine rotation speed (a predetermined rotation speed). A determination condition for an air-conditioner drive permission is that a current engine rotation speed reaches the air-conditioner drive permission engine rotation speed. In a case where the determination condition is not established, the meter control unit 53 requests the engine control unit 52 to increase the engine rotation speed, or the meter control unit 53 considers that the engine rotation speed is to increase and stands by. In either case, in a case where the engine rotation speed increases to satisfy the determination condition, the meter control unit 53 provides a compressor drive command (an ON command) to the compressor 63, more specifically, the electromagnetic clutch 63a of the compressor 63. Hereby, the compressor 63 is driven by engine power, so that the air conditioner device 6 starts operating.

FIG. 5 illustrates a second embodiment related to a data flow until the air conditioner device 6 starts operating after the air conditioner switch 93 is turned on. In the second embodiment, the air conditioner start operation signal sent to the air conditioner control unit 51 in response to the air conditioner switch 93 being turned on is directly sent to the engine control unit 52. The engine control unit 52 checks whether or not the current engine rotation speed satisfies the determination condition for an air-conditioner drive permission. In a case where the determination condition is not satisfied, the engine control unit 52 performs a control to increase the engine rotation speed, or the engine control unit 52 considers that the engine rotation speed is to increase and stands by. In either case, in a case where the engine rotation speed increases to satisfy the determination condition, the engine control unit 52 provides a compressor drive command (an ON command) to the compressor 63. Hereby, the compressor 63 is driven by engine power, so that the air conditioner device 6 starts operating.

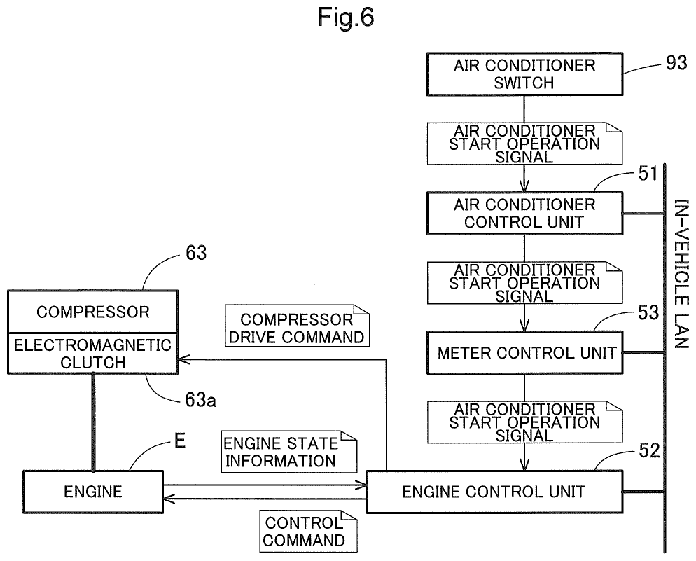

FIG. 6 illustrates a third embodiment related to a data flow until the air conditioner device 6 starts operating after the air conditioner switch 93 is turned on. In the third embodiment, the air conditioner start operation signal sent to the air conditioner control unit 51 in response to the air conditioner switch 93 being turned on is transferred to the meter control unit 53. The meter control unit 53 that has received the air conditioner start operation signal further transfers the air conditioner start operation signal to the engine control unit 52. The engine control unit 52 that has received the air conditioner start operation signal performs an air-conditioner drive permission determination in the way described in the second embodiment and finally provides a compressor drive command (an ON command) to the compressor 63. Hereby, the compressor 63 is driven by engine power, so that the air conditioner device 6 starts operating.

Although not illustrated herein, the air conditioner start operation signal generated in response to the air conditioner switch 93 being turned on may be first sent to the meter control unit 53, and after that, the air conditioner start operation signal may be sent to the air conditioner control unit 51. Its subsequent data flow is similar to the aforementioned embodiment.

### ALTERNATIVE EMBODIMENTS

(1) The above embodiments have described the air conditioner device 6 in consideration of a cooling function, but a heating function is also achievable by reversing a flowing direction of a medium to the compressor 63. Accordingly, the present invention is effective for both cooling and heating.
(2) In the above embodiments, engine state information used in the air-conditioner drive permission determination is an engine rotation speed, but other engine state information, e.g., information on an engine load, an engine rotation increase acceleration speed, an engine output, or the like may be used.
(3) Instead of the electromagnetic clutch 63a, other devices for coupling and decoupling of engine power may be used.
(4) In the above embodiments, in a case where the determination condition for an air-conditioner drive permission is not satisfied, a rotation speed increase command is provided to the engine E. However, instead of this, or in addition to this, the use of a device that consumes engine power may be restricted.
(5) In the above embodiments, the present invention is applied to a multipurpose vehicle but is also applicable to all work vehicles such as a mower, a snowplow truck, a tractor, and a harvester, other than the multipurpose vehicle.

Note that the configurations described in the above embodiments (including the alternative embodiments; the same applies hereinafter) can be applied in combination with configurations of other embodiments as long as no inconsistency occurs. The embodiments described in the present specification are illustrative and should not be construed as limiting the present invention. Modifications to the present invention are permissible, as long as they do not deviate from the scope that can achieve the objects of the present invention.

### INDUSTRIAL APPLICABILITY

The present invention is applicable to a work vehicle including a gasoline engine and an air conditioner device using engine power.

### DESCRIPTION OF THE REFERENCE NUMERALS

1: front wheel
2: rear wheel
3: body frame
4: cargo box
6: air conditioner device
8: drive cabin
9: driving section
9A: driver seat
9B: passenger seat
51: air conditioner control unit
52: engine control unit
53: meter control unit
61: air conditioning unit
62: condenser
63: compressor
63a: electromagnetic clutch
64: first refrigerant pipe
65: second refrigerant pipe
66: third refrigerant pipe
81: cabin frame
82: roof
83: windshield
84: rear window
85: side door
85a: side window
90: steering wheel
92: instrument panel
93: air conditioner switch
94: display
E: engine (gasoline engine)
T: transmission

What is claimed is:

1. A work vehicle, comprising:
a gasoline engine;
a drive cabin covering a cabin space;
an air conditioner device comprising a compressor driven by the gasoline engine, and an air conditioning unit configured to generate an air conditioning airflow supplied to the cabin space; and
an air conditioner control unit configured to control the air conditioner device, and
wherein the compressor is driven in response to a compressor drive command at start of the air conditioner device which compressor drive command is issued based on engine state information on a state of the gasoline engine.

2. The work vehicle according to claim 1, further comprising:
an engine control unit configured to control the gasoline engine and generate the engine state information.

3. The work vehicle according to claim 2, wherein:
the engine state information is an engine rotation speed,
the gasoline engine is controlled to satisfy a determination condition that the engine rotation speed reaches a predetermined rotation speed, in a case where the determination condition is not satisfied, and
the compressor drive command is issued in response to the determination condition being satisfied.

4. The work vehicle according to claim 3, wherein:
the engine control unit receives an air conditioner start operation signal via the air conditioner control unit which air conditioner start operation signal is to start driving of the air conditioner device, and
the engine control unit issues the compressor drive command.

5. The work vehicle according to claim 3, further comprising:
a meter control unit configured to manage a meter device displaying a current state of the work vehicle and to receive the engine rotation speed,
wherein the meter control unit receives an air conditioner start operation signal from the air conditioner control unit which air conditioner start operation signal is to start driving of the air conditioner device, and
wherein the meter control unit issues the compressor drive command based on the engine rotation speed.

6. The work vehicle according to claim 3, further comprising:
a meter control unit configured to manage a meter device displaying a current state of the work vehicle,
wherein the engine control unit receives an air conditioner start operation signal from the air conditioner control unit via the meter control unit which air conditioner start operation signal is to start driving of the air conditioner device, and
wherein the engine control unit issues the compressor drive command.
